(19) United States
(12) Patent Application Publication
(10) Pub. No.: US 2026/0303458 A1
(43) Pub. Date: Oct. 1, 2026

(54) Testing of Path-Based Network Device Configuration Update Commands

(71) Applicant: Arista Networks, Inc., Santa Clara, CA (US)

(72) Inventor: Charanjith Reddy Kunduru, Cupertino, CA (US)

(21) Appl. No.: 19/092,906

(22) Filed: Mar. 27, 2025

(51) Int. Cl. H04L 41/0869; H04L 41/082; H04L 67/133

(52) U.S. Cl. CPC H04L 41/0869; H04L 41/082; H04L 67/133

(57) ABSTRACT

A network device may be configured to receive path-based network device configuration update command(s) from external equipment. Based on a received indication from the external equipment, the network device may provide, to the external equipment, configuration difference information based on a scenario in which the path-based network device configuration update command(s) are applied to update running configuration information of the network device. The path-based network device configuration update command(s) may or may not actually be applied to update the running configuration information. The provided configuration difference information may be presented as command line interface (CLI)-based configuration commands.

### BACKGROUND

A communication system can include multiple network devices that are interconnected to form a network for conveying network traffic between hosts. A network device can maintain device configuration information such as running configuration information which specifies the manner in which the network device operates. The running configuration information can be changed during device operation to update the manner in which the network device operates.

### BRIEF DESCRIPTION OF THE DRAWINGS

FIG. 1 is a diagram of an illustrative networking system having network device(s) communicatively coupled to external equipment in accordance with some embodiments.

FIG. 2 is a diagram of an illustrative network device in accordance with some embodiments.

FIG. 3 is a diagram of illustrative processing circuitry configured to receive path-based device configuration update commands and to output corresponding command line interface (CLI)-based configuration commands in accordance with some embodiments.

FIG. 4A is a diagram of an illustrative network device configuration update request received by a network device from network device management equipment in accordance with some embodiments.

FIG. 4B is a diagram of an illustrative network device configuration update response provided by a network device to network device management equipment in accordance with some embodiments.

FIG. 5 is a diagram of illustrative processing circuitry configured to provide a configuration session for simulating application of path-based device configuration update commands in accordance with some embodiments.

FIG. 6 is a flowchart of illustrative operations for testing path-based device configuration update commands in accordance with some embodiments.

### DETAILED DESCRIPTION

A network can convey network traffic (e.g., in the form of frames, packets, etc., and/or in other formats) between hosts or generally between devices in the network. A network device can maintain device configuration information, such as running configuration information (sometimes referred to simply as running configuration), which specifies the manner in which the network device operates. Network device configuration information such as the running configuration may be updated during the course of device operation to dynamically update the manner in which the device operates. One illustrative manner in which device configuration can be updated is by providing the network device with path-based device configuration update commands (e.g., updates specified based on OpenConfig paths or other path-based or tree-based configuration state storage model). However, these path-based device configuration update commands when applied to change the running configuration can potentially cause issues that disrupt network device operations and/or network operations (e.g., causing a network outage).

To mitigate these issues and/or impart other advantages, the network device may be configured to provide feedback on received path-based device configuration update commands. In particular, the feedback may include configuration difference information generated based on simulating (e.g., in a sandboxed environment such as a configuration session) the path-based device configuration update commands being applied to update the running configuration. Accordingly, the network device may provide the configuration difference information without necessarily changing the actual running configuration based on the path-based device configuration update commands.

Additionally, a user (e.g., a network administrator) providing these configuration update commands may be more familiar with command line interface (CLI)-based configuration commands compared to path-based configuration commands. Accordingly, the network device may be configured to provide the configuration difference information using (e.g., as represented by) CLI-based configuration commands.

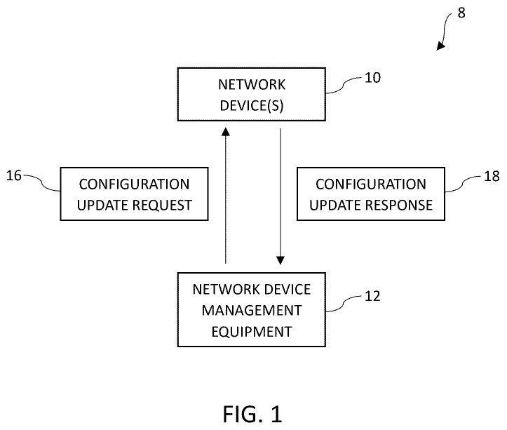

An illustrative networking system that includes one or more network devices configured to handle path-based network device configuration update commands (e.g., in the manner described above) is shown in FIG. 1. In the example of FIG. 1, the networking system may include one or more components of a network such as network 8. Network 8 may have any suitable scope. As examples, network 8 may include, be, and/or form part of one or more local segments, one or more local subnets, one or more local area networks (LANs), one or more virtual local area networks (VLANs), one or more campus area networks, one or more metropolitan area networks, one or more wide area networks, one or more datacenter networks, one or more cloud networks, etc. Network 8 may include a wired network portion based on wired technologies or standards such as Ethernet (e.g., using copper cables and/or fiber optic cables) and, if desired, may include wireless network portion(s) such as one or more wireless local area networks (WLANs) provided by wireless access point(s). If desired, network 8 may include internet service provider networks (e.g., the Internet) or other public service provider networks, private service provider networks (e.g., multiprotocol label switching (MPLS) networks), and/or other types of networks such as telecommunication service provider networks.

Network 8 may be implemented using and include one or more network devices 10 that handle (e.g., process by switching, routing, forwarding, modifying, etc.) network traffic to convey information for user applications between end hosts and/or for other applications, services, and functions generally between devices (e.g., network devices and/or end host devices). Network 8 can include networking equipment forming a variety of network devices 10 that interconnect end hosts of network 8. Network devices 10 of network 8 may include one or more switches (e.g., single-layer (Layer 2) switches, multi-layer (Layer 2 and Layer 3) switches, etc.), one or more bridges, one or more routers, one or more gateways, one or more hubs, one or more repeaters, one or more firewalls, one or more wireless access points, one or more devices serving other networking functions, one or more devices that include the functionality of two or more of these devices, and/or management equipment that manages and controls the operation of one or more of other network devices.

End hosts of network 8 can include computers, servers, portable electronic devices such as cellular telephones and laptops, other types of specialized or general-purpose host computing equipment (e.g., running one or more client-side and/or server-side applications), network-connected appliances, devices used by network administrators (sometimes referred to as administrator devices), network service devices, and/or management equipment that manages and controls the operation of one or more of other end hosts and/or network devices. These different types of equipment and/or devices based on which hosts of network 8 are implemented may sometimes be referred to herein generally as host devices.

To manage and/or monitor the operations of network 8, external equipment (external to a network device 10) such as network device management equipment 12 (sometimes referred to as network device configuration equipment) may be communicatively coupled to network device(s) 10. As one illustrative example, device management equipment 12 communicatively coupled to a network device 10 may include administrator device(s). An illustrative administrator device may be a computing device (e.g., a laptop, a computer, etc.) operated by a network administrator (e.g., a user with administrative-level access to network 8, thereby allowing the user to modify network device configuration or other network configuration and/or to receive notifications of network information). The computing device may include processing circuitry, memory circuitry, and input-output components (e.g., wireless communication circuitry, wired communication circuitry, and/or other circuitry that provide network interfaces for connectivity to network device 10, user input-output components such as a display, a keyboard, a mouse, etc. that provide user interfaces to facilitate the reception of user input and provide output to the user). The computing device (e.g., interfaces provided thereon) may be communicatively coupled to network device 10 via a direct cable connection (e.g., without other intervening network devices) or via intervening network devices (e.g., through one or more other devices 10, through portions of network 8 such as the Internet, etc.).

As another illustrative example, device management equipment 12 may include device management servers (sometimes referred to as network management servers). The servers may be implemented on server equipment. The server equipment may include server hardware such as one or more blade servers, one or more rack servers, and/or one or more tower servers. Compute devices and storage devices for implementing the functions of these servers may be provided as part of the server hardware. The compute devices may include one or more processors or processing units based on any suitable processor architecture(s). The storage devices may include non-volatile memory such as hard disk drive storage and solid-state storage, volatile memory such as random-access memory, and/or other storage circuitry. The storage devices may include one or more non-transitory (tangible) computer-readable storage media that store the operating system software and/or any other software code. The compute devices may run (e.g., execute) an operating system and/or other software (including firmware) stored on the one or more non-transitory computer-readable storage media to perform the desired operations of the server(s) (e.g., to provide the desired services and/or applications).

An illustrative device management server may execute services and/or applications for configuring, monitoring, and/or otherwise managing the operation of network device(s) 10 (e.g., by updating device configurations via configuration update requests, by receiving notifications of configuration updates via configuration update responses, etc.). In some illustrative scenarios, a device management server may manage the operations of network device(s) 10 (e.g., by updating device configuration and/or receiving notification of device configuration updates) based on network telemetry data, with or without receiving user input from an administrator device.

In some illustrative scenarios, a device management server may be communicatively coupled to an administrator device, may provide a user interface (e.g., a graphical user interface) at the administrator device through which the device management server receives user input from the administrator device, and may manage the operations of network device(s) 10 based on the received user input. In these illustrative scenarios, device management equipment 12 may include an administrator device and a server through which the administrator device accesses the configuration of network device 10 (e.g., to update device configuration and/or to receive device configuration states and other device information).

Depending on their configuration, equipment 12 and network devices 10 may communicate with each other in any suitable manner (e.g., via different suitable communication paths). As an example, these communication paths may include network paths through a portion of network 8 (e.g., through some network devices 10 therein, using the Internet, etc.).

Still referring to FIG. 1, a network device 10 may store network device configuration information (e.g., startup configuration information, running configuration information, etc.) that specify or define the manner in which network device 10 will operate or is operating. In illustrative examples described herein, network device 10 may operate with locally stored running configuration (sometimes referred to running configuration information) that defines network device operating behavior (e.g., traffic switching behavior, traffic routing behavior, enabled protocols, protocol parameters, enabled networking features such as traffic sampling, traffic mirroring, etc., external user access or user login behavior, etc.). The running configuration (information) may be maintained (e.g., stored) in one or more running configuration files, in one or more data structures, and/or generally in any suitable manner.

Network device management equipment 12 may sometimes provide configuration update requests that include commands or instructions to update device configuration of network device 10. Responsive to receiving these requests, network device 10 may update its configuration information (e.g., its running configuration) based on parameters and/or other information in these requests. Network 8 may include numerous network devices 10, each of which may have its configuration updated in this manner.

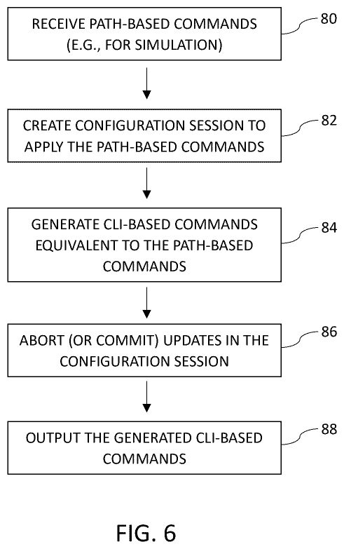

However, commands in configuration update requests can sometimes lead to faulty or undesired network device configuration being applied. To reduce the likelihood of faulty or undesired network device configuration, a network device 10 may be configured to provide feedback on device configuration update commands, e.g., in the form of configuration difference information. The configuration difference information may specify the difference between the original running configuration information and a version of the running configuration with the device configuration update commands applied. As shown in the example of FIG. 6, network device management equipment 12 may provide a network device configuration update request 16, containing configuration update commands, to a network device 10. The feedback (e.g., the configuration difference information) may be provided in the corresponding network device configuration update response 18, responsive to request 16, to network device management equipment 12.

Additionally, these configuration commands can often be provided in the form of path-based device configuration update commands that specify paths in a tree-based (or path-based) configuration state storage model, with each path (e.g., location) in the tree storing a corresponding configuration state (value). A path-based device configuration update command may specify a path in the tree (or generally a location in the configuration storage model) and an action for the path (e.g., adding a new value to a (new) path, updating an existing value of an existing path to a different value, deleting an existing value of an existing path, etc.).

However, users (e.g., network administrators) may not be as familiar with path-based device configuration update commands as they are with command line interface (CLI)-based configuration commands (e.g., because path-based configuration update commands rely on understanding the underlying configuration state storage model). Accordingly, network device 10 may provide the configuration difference information in the form of CLI-based configuration commands in response 18.

These examples described in connection with FIG. 1 are merely illustrative. Detailed configurations of device 10, equipment 12, request 16, and response 18 are further described herein.

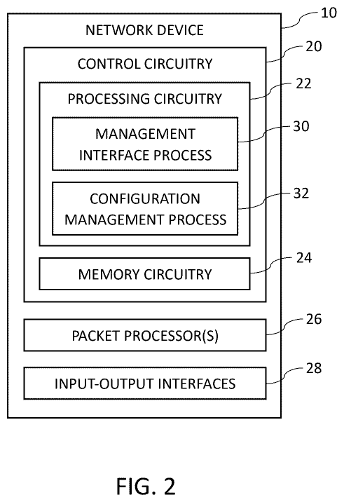

FIG. 2 is a diagram of an illustrative network device that may be used to implement any of network device(s) 10 in FIG. 1. As shown in FIG. 2, an illustrative network device 10 may include control circuitry 20 having processing circuitry 22 and memory circuitry 24, one or more packet processors 26, and input-output interfaces 28 (e.g., network interfaces implemented on exterior-facing ports). In one illustrative arrangement, network device 10 may be or form part of a modular network device system (e.g., a modular switch system having removably coupled modules usable to flexibly expand characteristics and capabilities of the modular switch system such as to increase ports, provide specialized functionalities, etc.). In another illustrative arrangement, network device 10 may be a fixed-configuration network device (e.g., a fixed-configuration switch having a fixed number of ports and/or a fixed hardware configuration).

Processing circuitry 22 may include one or more processors such as central processing units (CPUs), graphics processing units (GPUs), microprocessors, general-purpose processors, host processors, microcontrollers, digital signal processors, programmable logic devices such as field programmable gate array (FPGA) devices, application specific system processors (ASSPs), application specific integrated circuit (ASIC) processors, and/or other types of processors.

Processing circuitry 22 may run (e.g., execute) a network device operating system and/or other software (including firmware) that is stored on memory circuitry 24 communicatively coupled to processing circuitry 22. Memory circuitry 24 may include one or more non-transitory (tangible) computer-readable storage media that store the operating system software and/or any other software code, sometimes referred to as program instructions, software, data, instructions, or code. In particular, memory circuitry 24 may include non-volatile memory (e.g., flash memory, electrically-programmable read-only memory, a solid-state drive, hard disk drive storage, etc.), volatile memory (e.g., static or dynamic random-access memory), removable storage devices (e.g., storage devices removably coupled to device 10), and/or other types of memory circuitry.

Processing circuitry 22 and (at least a portion of) memory circuitry 24 as described above may sometimes be referred to collectively as control circuitry 20 (e.g., implementing a control plane of network device 10). Accordingly, processing circuitry 22 may also sometimes be referred to as control plane processing circuitry 22. As just a few examples, processing circuitry 22 may execute network device control plane software such as operating system software, routing policy management software, routing protocol agents or processes, routing information base agents, and other control software, may be used to support the operation of protocol clients and/or servers (e.g., to form some or all of a communications protocol stack), may be used to support the operation of packet processor(s) 26, may store packet forwarding information, may execute packet processing software, and/or may execute other software instructions that control the functions of network device 10 and the other components therein. These operations performed by processing circuitry 22 may make use of the information (e.g., parameters) provided in the running configuration such that device 10 operates in the intended (configured) manner.

Packet processor(s) 26 may be used to implement a data plane or forwarding plane of network device 10 and may therefore sometimes be referred to herein as data plane processor(s) 26 or data plane processing circuitry 26. Packet processor(s) 26 may include one or more processors such as programmable logic devices (e.g., field programmable gate array (FPGA) devices), application specific system processors (ASSPs), application specific integrated circuit (ASIC) processors, central processing units (CPUs), graphics processing units (GPUs), microprocessors, general-purpose processors, host processors, microcontrollers, digital signal processors, and/or other types of processors.

A packet processor 26 may receive incoming (ingress) network traffic via input-output interfaces 28, parse and analyze the received network traffic, process the network traffic based on packet forwarding decision data (e.g., in a forwarding information base) and/or in accordance with network protocol(s) or other forwarding policy, and forward (or drop) the network traffic accordingly (e.g., egress the processed network traffic via input-output interfaces 28). These operations performed by processing circuitry 26 may make use of the information (e.g., parameters) provided in the running configuration such that device 10 operates in the intended (configured) manner. The packet forwarding decision data may be stored on memory circuitry integrated as part of and/or separate from packet processor 26 (e.g., on content-addressable memory), and/or on a portion of memory circuitry 24. Memory circuitry for packet processor 26 may include volatile memory, non-volatile memory, and/or other types of memory circuitry.

Input-output interfaces 28 may include one or more different types of communication interfaces such as Ethernet interfaces, optical interfaces, and/or other types of communication interfaces for connecting network device 10 to the Internet, a local area network, a wide area network, a mobile network, and/or generally other network device(s) 10, peripheral devices, and computing equipment (e.g., host equipment as server equipment, host devices, etc.). In illustrative configurations described herein as an example, input-output interfaces 28 may include Ethernet interfaces implemented using and therefore include (Ethernet) ports. In particular, physical layer and/or data link layer interface circuitry in network device 10 may be coupled to the ports and use the ports to form Ethernet interfaces with the desired interface configurations.

If desired, network device 10 may include other components such as power supply circuitry, power management circuitry, a system bus and/or other communication paths that communicatively couple the components of network device 10 to one another, etc. As an example, each component of network device 10 may be communicatively coupled to at least control circuitry 20 (e.g., processing circuitry 22 and/or memory circuitry 24) via one or more paths (e.g., in the system bus or elsewhere) that enable the reception and transmission of control signals, data, and/or other information therebetween.

A network device 10 (e.g., as described in connection with FIGS. 1 and 2) may be configurable to operate in different manners in the network. As examples, depending on its configuration, network device 10 may form different numbers and types of network interfaces, route network traffic in different manners, switch network traffic in different manners, execute different protocols, enable different features, etc. In particular, this type of configuration information defining the manner in which device 10 operates or should operate may be stored (e.g., in memory circuitry 24) as one or more pieces of configuration information.

Network device 10 (e.g., memory circuitry 24) may store different types of configuration information specifying device configuration for use in different scenarios. In particular, device 10 may store a collection of startup configuration data specifying device startup configuration information, may store a collection of running configuration data specifying device running configuration information, and/or may store other types of device configuration information. In illustrative configurations described herein as examples, some types of device configuration information such as running configuration information may be updated dynamically during normal operation of network device 10.

To provide (software) interfaces for communicating with external equipment, processing circuitry 22 may execute a management interface process 30 (e.g., by executing corresponding software instructions stored on memory circuitry 24). Management interface process 30 (sometimes referred to as management interface agent 30) may, among other functions, perform interfacing operations to receive, process, transmit, and/or otherwise handle communication messages (e.g., request messages, response messages, etc.) with external equipment such as management equipment 12. In some illustrative configuration described herein as an example, management interface process 30 may be configured to perform operations in accordance with OpenConfig. These operations may include providing a remote procedure call (RPC)-based network management interface (NMI) (e.g., to receive device configuration update requests from, to provide device configuration update responses to, and/or to otherwise communicate with RPC-based NMI clients such as gRPC-based gNMI clients). If desired, management interface process 30 may be implemented in other manners and/or to provide other (software) interfaces (e.g., a network configuration protocol (NETCONF) interface, a RESTCONF interface, etc.) for communicating with other types of clients (e.g., receiving and processing requests from other types of clients, generating and transmitting responses to other types of clients, etc.).

In particular, the interface(s) provided by processing circuitry 22 (e.g., when executing process 30) may be used to receive request(s) 16 (FIG. 1) from equipment 12, process received request(s) 16, generate corresponding response(s) 18 (FIG. 1), and provide response(s) 18 to equipment 12.

To facilitate the management of network device configuration information, processing circuitry 22 may execute a configuration management process 32 (e.g., by executing corresponding software instructions stored on memory circuitry 24). Configuration management process 32 (sometimes referred to as configuration management agent 32) may, among other functions, perform operations to modify, provide access to, and/or otherwise handle device configuration information such as startup configuration information, running configuration information, etc. Configurations in which process 32 manages (e.g., performs configuration updates of, simulates changes to, etc.) running configuration information are sometimes described herein as examples. If desired, process 32 may manage other types of configuration information (e.g., startup configuration information) in addition to or instead of running configuration information.

In illustrative configurations sometimes described herein as an example, processing circuitry 22 (e.g., when executing process 32) may also perform certain operations such as the generating, maintaining, outputting, and/or other types of handling of device configuration difference information as described herein. This example is merely illustrative. If desired, processing circuitry 22 may execute other processes instead of or in addition to process 32 to perform these operations.

The configuration of processing circuitry 22 as described above is merely illustrative. In general, processing circuitry 22 may be organized in other illustrative manners (e.g., execute different sets of processes) to perform the operations described herein. Accordingly, processing circuitry 22 is sometimes referred to as being configured to perform these operations in connection with the forming of interface(s) that facilitate the reception of device configuration update requests and the transmission of device configuration responses, the updating and management of network device configuration information, and the generation and handling of configuration difference information, among other operations described herein, instead of referring specifically to process 30, process 32, and/or other processes that may perform these operations. These operations may be stored as (software) instructions on the one or more non-transitory computer-readable storage media (e.g., in portion(s) of memory circuitry 24 in network device 10). The corresponding processing circuitry (e.g., one or more processors of processing circuitry 22 in network device 10) may process or execute the respective instructions to perform these operations.

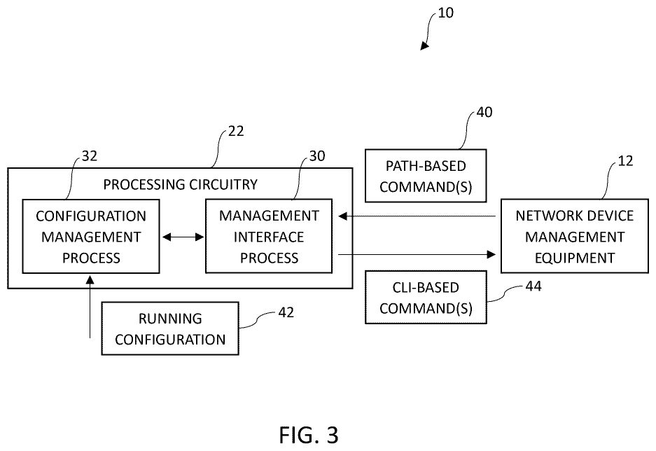

FIG. 3 is a diagram of illustrative processing circuitry in a network device (e.g., processing circuitry 22 in FIG. 2) configured to receive commands such as path-based network device configuration update command(s) 40 and/or other input from network device management equipment 12. In the example of FIG. 3, processing circuitry 22 (e.g., when executing management interface process 30) may provide one or more application programming interfaces (APIs) such as a remote procedure call (RPC)-based network management interface (e.g., a gRPC-based gNMI), a NETCONF interface, a RESTCONF interface, etc. As one illustrative example, these interface(s) may be provided by executing process 30, which facilitates network device management using OpenConfig.

Using these software interface(s) (and corresponding input-output interfaces 28 in FIG. 2), processing circuitry 22 may communicate with external equipment such as network device management equipment 12 (e.g., an administrator devices, a device management server, etc.). In other words, external equipment 12 may provide the corresponding client-side interface(s) to communicate with (server-side) interfaces provided by processing circuitry 22 (e.g., when executing process 30). In particular, processing circuitry 22 (e.g., when executing process 30) may obtain (e.g., receive) input such as one or more device configuration update commands (e.g., path-based configuration update commands 40) from equipment 12 (e.g., from a device management application executing on equipment 12) and/or from other sources of device configuration information.

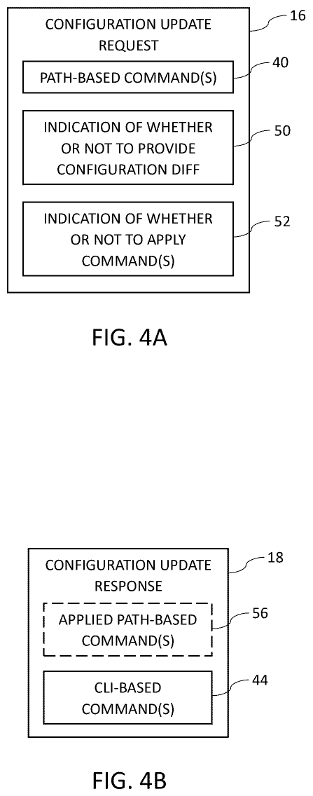

In particular, a set of path-based network device configuration update command(s) 40 may be received in a corresponding configuration update request (e.g., request 16 in FIG. 1) received by processing circuitry 22 from management equipment 12. The configuration update request may be conveyed in one or more messages. FIG. 4A shows an illustrative network device configuration update request 16 (e.g., request 16 in FIG. 1).

As shown in the example of FIG. 4A, configuration update request 16 may include a set of one or more path-based network device configuration update commands 40. Certain commands (e.g., commands 40) may be path-based because they address and operate on configuration states maintained (logically) as paths (e.g., branches or generally locations) in a tree-based data model. As examples, these paths may be OpenConfig paths in the OpenConfig configuration state storage model or may be paths in a vendor-specific configuration state storage model. Regardless of the manner in which these paths are organized, each path may specify a state (e.g., one or more values) for network device configuration.

In particular, each path-based network device configuration update command 40 may specify a path within a path-based (or-tree-based) configuration state storage model and may specify a corresponding action to be performed for that path. As a first example, a command 40 may include an action to set a new value for a (new) path, thereby adding a new configuration state (e.g., to specify a new configuration parameter for a new or existing feature, adding a new feature or functionality, etc.). As a second example, a command 40 may include an action to replace an existing value for an existing path with a different (new) value, thereby updating an existing configuration state (e.g., to specify a different configuration parameter, feature, functionality, etc., than what previously existed). As a third example, a command 40 may include an action to delete an existing value for a path, thereby removing an existing configuration state (e.g., to remove a configuration parameter, feature, functionality, etc., that previously existed). The set of path-based command(s) 40 may include one or more of these types of path-based commands and/or other path-based commands.

In addition to obtaining path-based command(s) 40 from within received request 16, processing circuitry 22 may also obtain, from within the same received request 16, one or more options specifying how path-based command(s) 40 are to be processed. A first option may be an indication 50 of whether or not to provide configuration difference information (e.g., simulated or draft running configuration changes if path-based command(s) 40 are applied). In some illustrative examples described herein, the configuration difference information is represented using command line interface (CLI)-based configuration command(s) (e.g., equivalent to path-based command(s) 40). A second option may be an indication 52 of whether or not to apply (e.g., commit) path-based command(s) 40 to actually update the running configuration of device 10 and change the operating behavior of device 10. In other words, if indicated by indication 52 (e.g., that command(s) 40 are not to be applied), path-based command(s) 40 may be used to generate configuration difference information without actually affecting the running configuration and the operation of device 10, thereby facilitating testing of path-based commands 40. On the other hand, if indicated by indication 42 (e.g., that command(s) 40 are to be applied), path-based command(s) 40 may be used to update the running configuration and the operation of device 10 (in addition to generating the configuration difference information).

In some illustrative configurations described herein as an example, network device configuration update request 16 may be a request for an RPC or more specifically a set request for an RPC-based NMI protocol (e.g., a gNMI protocol). The set request may include path-based configuration update commands(s) 40 and may include, using extension(s) in the set request (e.g., using one or more extension fields in the set request), the one or more options specifying how path-based configuration update command(s) 40 are to be processed.

As one illustrative example, the presence of a configuration difference extension field in the set request may serve as indication 50 to provide the configuration difference information (e.g., represented by CLI-based commands indicating running configuration differences when path-based commands 40 are applied compared to when the path-based commands 40 are not applied). If desired, the configuration difference extension field may include a value (e.g., a Boolean value) that provides indication 52 indicating whether or not to apply commands 40 to change the running configuration and the operation of network device 10. In other words, indications 50 and 52 may be provided as part of the same extension field in the set request.

In some illustrative configurations sometimes described herein as an example, some request(s) 16 may include an indication 50 to provide configuration difference information (e.g., represented by CLI-based command(s)) and an indication 52 not to apply command(s) 40 to the running configuration. This combination of indications may serve as an indication for configuration testing (e.g., testing the configurations associated with command(s) 40 being applied to the running configuration without actually applying these configurations to affect network device operations). In other instances, indication 52 may be an indication to apply command(s) 40 to the running configuration.

These examples for request 16 are merely illustrative. If desired, request 16 may be another type of request (e.g., a request in accordance with another protocol). If desired, indications 50 and 52 may be provided in other manners in request 16.

Referring back to FIG. 3, processing circuitry 22 (e.g., when executing process 30) may process path-based network device configuration update command(s) 40 in a corresponding request 16 (FIG. 4) based on indications 50 and/or 52 accompanying command(s) 40 in the same request 16. Upon receiving commands 40, processing circuitry 22 (e.g., when executing process 30) may process command(s) 40 based on indications 50 and 52. In particular, based on indication 50 being an indication to provide configuration difference information, processing circuitry 22 may obtain (e.g., generate) the configuration difference information, e.g., by management interface process 30 communicating with configuration management process 32. For example, processing circuitry 22 (e.g., when executing process 32) may access running configuration information 42 (e.g., stored on memory circuitry 24) and identify difference(s) between running configuration information 42 and a version (e.g., a modified copy) of running configuration information 42 applied with command(s) 40 to generate the configuration difference information.

Based on indication 52 being an indication to apply path-based network device configuration update command(s) 40, processing circuitry 22 may apply command(s) 40 to update the running configuration of device 10. Based on indication 52 being an indication not to apply path-based network device configuration update command(s) 40, processing circuitry 22 may not apply command(s) 40 to update the running configuration of device 10.

In scenarios in which processing circuitry 22 is configured to provide the configuration difference information (e.g., when indication 50 indicates that configuration differences should be provided in a response), processing circuitry 22 (e.g., when executing process 32) may provide (e.g., generate) the configuration difference information as represented by CLI-based configuration commands 44. Accordingly, processing circuitry 22 (e.g., when executing process 30) may provide the generated CLI-based configuration commands 44 to network device management equipment 12 as output.

In particular, CLI-based configuration command(s) 44, among other information, may be provided in a corresponding network device configuration update response, (e.g., response 18 responsive to request 16 in FIG. 1), transmitted by processing circuitry 22 to management equipment 12. The network device configuration update response may be conveyed as one or more messages. FIG. 4B shows an illustrative network device configuration update response 18 (e.g., response 18 in FIG. 1).

As shown in the example of FIG. 4B, network device configuration update response 18 may include the one or more CLI-based configuration commands 44 indicative of the configuration difference information (e.g., provided as indicated by indication 50 in the corresponding request 16). Certain commands (e.g., commands 44) may be CLI-based commands because they are interpretable by a command line interface of a network device (e.g., implemented by processing circuitry 22). In particular, CLI-based configuration command(s) 44 may correspond to and be equivalent to CLI versions of path-based device configuration update commands 40 in request 16. In other words, processing circuitry 22 may have converted the configuration changes indicated by received path-based network device configuration update command(s) 40 into corresponding CLI-based configuration commands 44 for output.

If some scenarios, in addition to providing CLI-based command(s) 44 (e.g., indicating the requested configuration difference information) within network device configuration update response 18, processing circuitry 22 may provide the path-based configuration update command(s) 56 applied (e.g., command(s) 44, if all are applied) to change the running configuration of device 10 and/or an indication of the path-based command(s) having been applied to change the running configuration of device 10 in response 18. In particular, these scenarios may occur when indication 52 in the corresponding request 16 is an indication to apply path-based command(s) 40.

In scenarios in which indication 52 in the corresponding request 16 is an indication not to apply commands 40, response 18 provided by processing circuitry 22 may lack any indication of path-based commands 40 having been applied and/or otherwise indicate that path-based command(s) 40 in request 16 have not been applied.

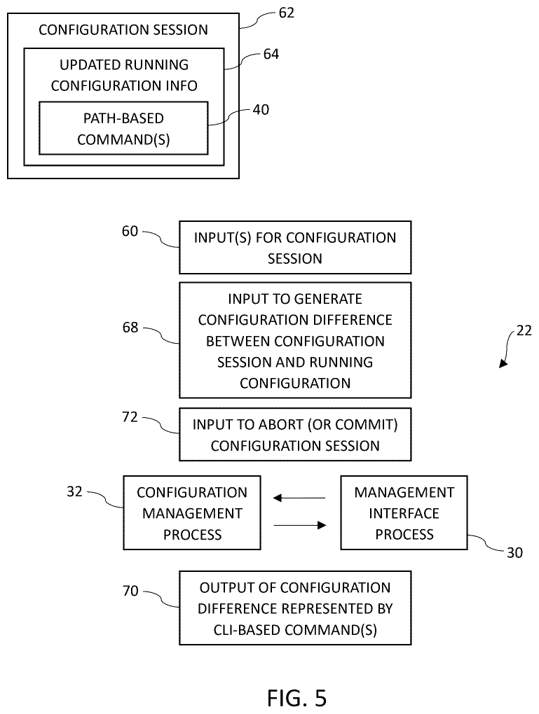

In one illustrative configuration of processing circuitry 22 (FIG. 3), processing circuitry 22 may perform the operations described in connection with FIGS. 3, 4A, and 4B when executing processes 30 and 32. In particular, FIG. 5 is a diagram of illustrative processing circuitry 22 executing management interface process 30 and configuration management process 32 to handle received path-based network device configuration update commands. As shown in the example of FIG. 5, processing circuitry 22 may provide (e.g., create, initiate, etc.) a configuration session 62 in response to receiving path-based commands 40 (FIG. 3) in a corresponding request 16 (FIG. 4A). In particular, processing circuitry 22 (e.g., when executing process 30) may supply one or more input(s) 60 (e.g., an executable command to initiate a configuration session) to configuration management process 32 to provide configuration session 62.

In providing configuration session 62, processing circuitry 22 (e.g., configuration management process 32) may provide a sandboxed environment (e.g., maintained on memory circuitry 24 in FIG. 2) in which a version (e.g., a copy) of the running configuration information 64 can be modified or updated without changing the actual running configuration information 42 (FIG. 3), thereby not impacting the operational behavior of device 10. After providing configuration session 62, processing circuitry 22 may update (e.g., modify) the copy of running configuration information 64 in configuration session 62 based on path-based configuration update command(s) 40. In some instances, command(s) 40 may be modified or standardized to be in a format interpretable by the configuration session 62 and/or process 32 before being applied to the copy of running configuration information 64 in configuration session 62.

In particular, processing circuitry (e.g., when executing process 30) may supply, to process 32, additional input(s) 60 (e.g., command(s) 40 or modified version(s) of commands 40 acceptable in configuration session 62) within configuration session 62 to obtain the updated version (e.g., updated copy) of running configuration information 64 with command(s) 40 applied with configuration session 62. In such a manner, changes to network device running configuration may be simulated using the updated version of the running configuration information 64 within configuration session 62, without actually changing running configuration information 42 (FIG. 3).

Based on indication 50 accompanying command(s) 40 (e.g., in the same request 16 in FIG. 4A) indicating that configuration difference information should be provided, processing circuitry 22 (e.g., when executing process 30) may facilitate the generation of configuration difference information. In particular, after configuration session 62 has been used to obtain the updated copy of running configuration information 64 (e.g., based on process 32 processing input(s) 60 applying command(s) 40), processing circuitry 22 (e.g., when executing process 30) may supply input 68 (e.g., an executable instruction), to process 32, to generate configuration difference information between the updated copy of running configuration information 64 in configuration session 62 and the actual running configuration information 42 (FIG. 3).

Processing circuitry 22 (e.g., when executing process 32) may provide, to process 30, output 70 containing configuration difference information generated in response to input 68. In particular, processing circuitry 22 (e.g., when executing process 32) may compare the updated copy of running configuration information 64 in configuration session 62 and the actual running configuration information 42 to identify any differences between the updated copy of running configuration information 64 in configuration session 62 and the actual running configuration information 42. The generated configuration difference information may contain, identify, and/or otherwise indicate any (e.g., all) of these identified difference(s).

In illustrative configurations sometimes described herein as an example, the configuration difference information (e.g., the identified difference(s) between the updated copy of running configuration information 64 in configuration session 62 and the actual running configuration information 42) may be represented by CLI-based configuration commands (e.g., command(s) 44 in FIGS. 3 and 4B). In other words, if these CLI-based commands were applied to running configuration information 42 (FIG. 3), the resulting updated version of running configuration information would be the updated copy of running configuration information 64. Accordingly, CLI-based configuration command(s) 44 may be functionally the same as path-based commands 40 but may differ in syntax.

In some instances, processing circuitry 22 (e.g., when executing process 32) may natively generate CLI-based configuration command(s) 44 when performing a configuration difference generation operation (e.g., as instructed by input 68) to generate the configuration difference information. In other instances, processing circuitry 22 (e.g., when executing process 32) may generate configuration difference information in a different form and may perform a conversion (from the generated configuration difference information in the different form) to obtain CLI-based configuration commands 44. Regardless of how CLI-based configuration commands 44 are obtained, they may be output by process 32 as output 70 to process 30 for further output to management equipment 12 (e.g., in response 18 in FIG. 4B).

In other words, configured in the manner described above, processing circuitry 22 (e.g., when executing process 32) may generate the configuration difference information based on comparing the actual running configuration information 42 (FIG. 3) with the draft (e.g., simulated) changes to running configuration information in a sandboxed environment (e.g., represented by updated version of running configuration information 64 in configuration session 62). Processing circuitry 22 (e.g., when executing process 32) may generate a response 18 containing the generated configuration difference information represented by CLI-based configuration command(s) 44 (FIGS. 3 and 4B) and provide the response 18 to management equipment 12.

After generating the configuration difference information (e.g., CLI-based configuration command(s) 44), processing circuitry 22 may abort configuration session 62 (e.g., discard the updated version of updated running configuration information 64 in configuration session 62 without applying these draft or simulated updates to running configuration information 42) or may commit configuration session 62 (e.g., apply the updated version of updated running configuration information 64 in configuration session 62 to running configuration information 42). In particular, processing circuitry 22 (e.g., when executing process 30) may provide corresponding input 72 (e.g., an executable instruction for configuration session 62) to instruct process 32 to abort or commit configuration session 62.

As a first example, based on indication 52 in received request 16 being an indication that path-based device configuration update command(s) 40 not be applied, processing circuitry 22 (e.g., when executing processor 32) may receive input 72, from process 30, to abort configuration session 62 and may abort configuration session 62 (based on input 72) without making any updates to running configuration information 42 using the updated configuration information 64 provided in configuration session 62. In such a manner, changes made based on applying command(s) 40 in configuration session 62 may only be simulated in configuration session 62 and not actually applied to running configuration information 42. Accordingly, in this example, processing circuitry 22 (e.g., when executing process 32) may provide a response 18 that lacks any indication of command(s) 40 being applied to running configuration 42 (e.g., lack applied command(s) 56 in FIG. 4B).

As a second example, based on indication 52 in received request 16 being an indication that command(s) 40 are to be applied, processing circuitry 22 (e.g., when executing process 32) may receive input 72, from process 30, to commit configuration session 62 and may commit configuration session 62 (based on input 72) and update running configuration information 42 by applying the updated configuration information 64 provided in configuration session 62. Accordingly, in this example, processing circuitry 22 (e.g., when executing process 32) may provide a response 18 that includes an indication of command(s) 40 being applied to running configuration 42 (e.g., includes command(s) 40 as applied command(s) 56 in FIG. 4B).

FIG. 6 is a flowchart of illustrative operations for providing configuration difference information in the form of CLI-based configuration commands for path-based network device configuration update commands. In particular, these operations may be performed by one or more processors of network device 10 (e.g., control plane processing circuitry 22 in FIG. 2) using other components of network device 10 (e.g., memory circuitry 24, packet processors 26, interfaces 28, etc., in FIG. 2). In some configurations described herein as an illustrative example, the operations described in connection with FIG. 6 may be performed by the one or more processors executing software instructions stored on memory circuitry (e.g., one or more non-transitory computer-readable storage media). If desired, one or more operations described in connection with FIG. 6 may be performed by and/or using other dedicated (specialized) hardware components.

At block 80, one or more processors of a network device (e.g., forming control plane processing circuitry 22) may receive, from external network device management equipment, path-based device configuration update commands. In one illustrative configuration sometimes described herein as an example, these path-based commands may be accompanied (e.g., in the same request or message) by processing options. These options may indicate a simulation or test run of the path-based commands (e.g., rather than changing the actual running configuration of the network device).

At block 82, the one or more processors may create a configuration session in which the path-based commands can be applied to a version (e.g., a copy) of the running configuration information, without actually impacting the working running configuration of the network device. In particular, the configuration session creates a sandboxed environment (e.g., for the simulation of the path-based commands).

At block 84, the one or more processors may generate CLI-based commands equivalent to the path-based commands. In other words, CLI-based commands may represent a configuration difference between the current running configuration and an updated version of the running configuration with the path-based commands applied.

At block 86, the one or more processors may abort the configuration session (and the updates made therein) in scenarios in which the path-based commands are only intended to be simulated on the network device. In other scenarios (e.g., when indicated as an option along with the path-based commands), the one or more processors may commit the updates made in the configuration session to actually change the running configuration of the network device.

At block 88, the one or more processors may output the generated CLI-based commands, representing configuration different information, to the external network device management equipment, e.g., in a corresponding configuration update response to a configuration update request in which the path-based commands are received at block 80.

In some illustrative configurations described herein, the operations described in connection with blocks 80, 82, 84, 86, and 88 may include illustrative operations performed by network device 10 (e.g., by processing circuitry 22) as described in connection with FIGS. 1-6. If desired, the operations described in connection with blocks 80, 82, 84, 86, and 88 may include other types of operations.

The methods and operations described above in connection with FIGS. 1-6 may be performed by the components of one or more network devices 10 (FIG. 1) and/or one or more servers or other host equipment using software (including firmware) and/or hardware (e.g., dedicated circuitry or hardware). Software code for performing these operations may be stored on one or more non-transitory computer-readable storage media (e.g., tangible computer-readable storage media) stored on one or more of the components of the network device(s) and/or server(s) or other host equipment. The software code may sometimes be referred to as software, data, instructions, program instructions, or code. The one or more non-transitory computer-readable storage media may include drives, non-volatile memory such as non-volatile random-access memory (NVRAM), removable flash drives or other removable media, other types of random-access memory, etc. Software stored on the non-transitory computer readable-storage media may be executed by processing circuitry on one or more of the components of the network device(s) and/or server(s) or other host equipment (e.g., compute devices of server equipment, processing circuitry of computing devices, processing circuitry of network devices, etc.).

The foregoing is merely illustrative and various modifications can be made to the described embodiments. The foregoing embodiments may be implemented individually or in any combination.

What is claimed is:

1. A network device comprising:
memory circuitry; and
processing circuitry coupled to the memory circuitry and configured to:
receive, from network device management equipment, a network device configuration update request that includes one or more path-based network device configuration update commands and an indication to provide configuration difference information;
obtain, based on the indication, the configuration difference information by simulating the one or more path-based network device configuration update commands being applied to running configuration information of the network device; and
provide, to the network device management equipment, one or more command line interface (CLI)-based configuration commands representing the configuration difference information.

2. The network device defined in claim 1, wherein the processing circuitry is configured to:
provide a configuration session, wherein the one or more path-based network device configuration update commands are simulated in the configuration session to be applied to a copy of the running configuration information and wherein the copy of the running configuration information applied with the one or more path-based network device configuration update commands provides an updated copy of the running configuration information in the configuration session.

3. The network device defined in claim 2, wherein the configuration difference information is obtained by comparing the updated copy of the running configuration information in the configuration session to the running configuration information.

4. The network device defined in claim 3, wherein the processing circuitry is configured to:
identify one or more differences between the updated copy of the running configuration information in the configuration session and the running configuration information by comparing the updated copy of the running configuration information in the configuration session to the running configuration information; and
obtain the one or more CLI-based configuration commands based on the one or more identified differences.

5. The network device defined in claim 2, wherein the received network device configuration update request includes an additional indication of whether to apply the one or more path-based network device configuration update commands to update the running configuration information.

6. The network device defined in claim 5, wherein the processing circuitry is configured to abort the configuration session without applying the updated copy of the running configuration information in the configuration session based on the additional indication being an indication not to apply the one or more path-based network device configuration update commands.

7. The network device defined in claim 6, wherein the processing circuitry is configured to provide the one or more CLI-based configuration commands in a network device configuration updated response, to the network device management equipment, responsive to the network device configuration update request and wherein the network device configuration update response lacks an indication that the running configuration information has been updated using the one or more path-based network device configuration update commands.

8. The network device defined in claim 5, wherein the processing circuitry is configured to apply the updated copy of the running configuration information in the configuration session based on the additional indication being an indication to apply the one or more path-based network device configuration update commands.

9. The network device defined in claim 8, wherein the processing circuitry is configured to provide the one or more CLI-based configuration commands in a network device configuration update response, to the network device management equipment, responsive to the network device configuration update request and wherein the network device configuration update response includes an indication that the running configuration information has been updated using the one or more path-based network device configuration update commands.

10. The network device defined in claim 1, wherein the one or more path-based network device configuration update commands each identifies a path and a corresponding action for the path.

11. The network device defined in claim 10, wherein the action of a given path-based network device configuration update command of the one or more path-based network device configuration update commands comprises:
adding a new value for the path of the given path-based network device configuration update command,
updating an existing value for the path of the given path-based network device configuration update command to a different value, or
deleting the existing value for the path of the given path-based network device configuration update command.

12. The network device defined in claim 1, wherein the network device configuration update request is for a remote procedure call.

13. The network device defined in claim 1, wherein the network device configuration update request is a set request based on a remote procedure call (RPC)-based network management interface protocol.

14. The network device defined in claim 13, wherein the indication is specified using an extension field in the set request.

15. A network device comprising:
memory circuitry; and
processing circuitry coupled to the memory circuitry and configured to:
receive, from external equipment, a network device configuration update request that includes one or more path-based network device configuration update commands;
apply the one or more path-based network device configuration update commands in a configuration session to obtain updated device configuration information in the configuration session;
provide one or more differences between the updated device configuration information in the configuration session and running configuration information of the network device, wherein the one or more differences are represented using one or more command line interface (CLI)-based configuration commands; and
provide, to the external equipment, a network device configuration update response containing the one or more CLI-based configuration commands.

16. The network device defined in claim 15, wherein the network device configuration update request includes an indication to provide configuration difference information for the one or more path-based network device configuration update commands.

17. The network device defined in claim 16, wherein the network device configuration update request includes an additional indication of whether to apply the one or more path-based network device configuration update commands to update the running configuration information.

18. The network device defined in claim 17, wherein the network device configuration update request is a set request based on a remote procedure call (RPC)-based network management interface protocol and wherein the indication and the additional indication are specified using an extension field in the set request.

19. A network device comprising:
memory circuitry; and
processing circuitry coupled to the memory circuitry and configured to:
receive, from network device management equipment, a message containing one or more path-based network device configuration update commands and an indication of configuration testing;
based on the indication of configuration testing, provide, to the network device management equipment, one or more command line interface (CLI)-based configuration commands corresponding to the one or more path-based network device configuration update commands without updating running configuration information of the network device based on the one or more path-based network device configuration update commands.

20. The network device defined in claim 19, wherein the indication of configuration testing comprises a first indication to provide configuration difference information and a second indication not to apply the one or more path-based network device configuration update commands to update the running configuration information.
